(19) United States
(12) Patent Application Publication
(10) Pub. No.: US 2007/0300251 A1
(43) Pub. Date: Dec. 27, 2007

(54) METHOD FOR PLAYING INTERACTIVE SHOWS IN INTERACTIVE SYSTEM

(76) Inventor: Sheng-Fu HSU, Kaohsiung County (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/422,495

(22) Filed: Jun. 6, 2006

(51) Int. Cl. H04N 7/173; H04N 7/16

(52) U.S. Cl. 725/24; 725/23

(57) ABSTRACT

A method and system are provided to determine whether or not an interactive show shall be interrupted and switched to a next show by a predetermined rule with regard to a ballot of viewers at terminals in an interactive system.

### FIELD OF THE INVENTION

This invention relates to a method for broadcasting interactive shows in an intemnet system, digital TV system, and the like.

### BACKGROUND

Traditional show systems involve a unidirectional or non-interactive transmission system, e.g., in a traditional intemnet system, a server broadcasts a program to all the terminals, and the viewers at the terminals can select the address to watch the program or switch to another address without watching the program. The viewers do not have the control power to request the server to terminate a show on air and play the next one.

FIG. 1 is a prior art system in which a server (not shown) traditionally prepares a pre-recorded show database to broadcast the prerecorded shows sequentially according to a pre-determined sequence. The end users or the viewers can watch the shows at their terminals but have no control power to command the server to skip the aired show and play a next show. FIG. 1 shows a traditional program in which shows are sent to terminals by the server (not shown) that broadcasts the shows sequentially to terminal 1, terminal 2, and terminal 3.

### SUMMARY OF THE INVENTION

The object of this invention is to give the viewers a right to vote on or against an aired show to command the server to continue or skip the show based on a predetermined rule of ballot.

### BRIEF DESCRIPTION OF THE DRAWINGS

FIG. 1 is a prior art system.

FIG. 2 is the algorithm of an embodiment of the present invention.

FIG. 3 is a preferred embodiment of the present invention.

FIG. 4 is a process for collecting shows from end users.

FIG. 5A is statistics information of ballot shown on the screen of a terminal.

FIG. 5B is a Vote buttons shown on the screen of a terminal.

FIG. 6 is a rejection rate indicator.

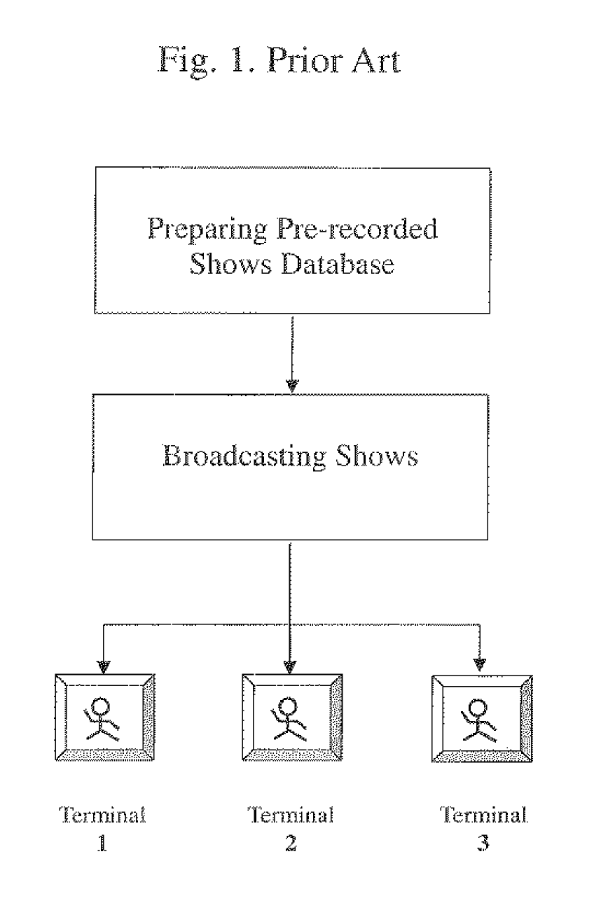

### DETAILED DESCRIPTION OF THE INVENTION

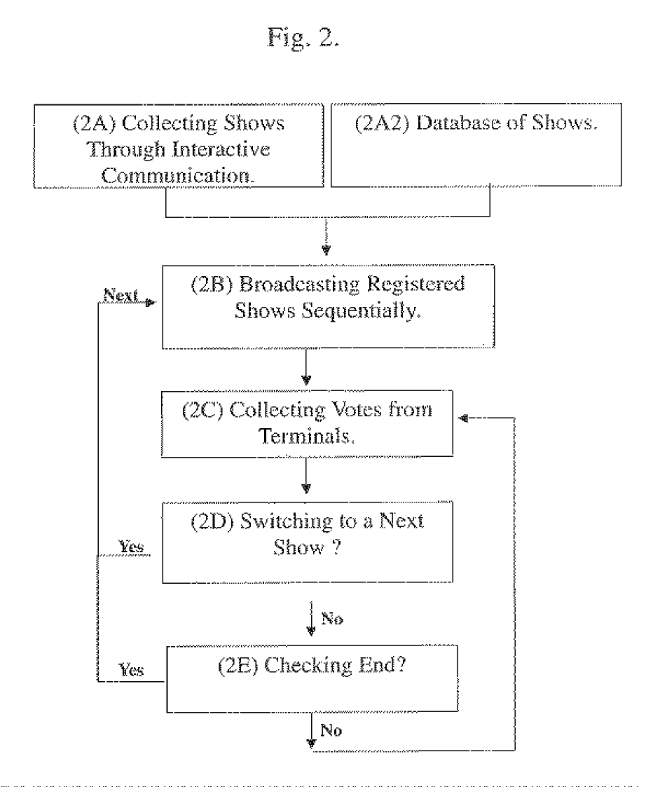

FIG. 2 is the algorithm of an embodiment of the present invention. A server (not shown) collects shows through an interactive communication system (2A), then broadcasts registered shows sequentially to terminals on the interactive system (2B) to which one can connect and watch the broadcasted shows. The server gives each terminal a right to vote on or against the aired show (2C). If, e.g., one half of the total connected terminals votes against the aired show, then the server shall skip the aired show and play a next show. The system shall check the ballot, if the quantity or percentage of votes against the show meets a threshold, then the server shall stop immediately the show on the air and play a next one (2D). If the quantity or percentage of votes against the show below the threshold, the show shall continue until its end (2E).

For the show collecting step 2A, a user can perform a show before a camera after registering to the server responsive to the interactive communication provided by the server. Alternatively, the user can upload a prerecorded show instead of live performance. A time period is preset by the server system for the viewer to perform or upload a show.

Step 2A indicates that the shows are collected from the users or viewers; however, a data base of shows (2A2) can be used to broadcast.

A show to be collected can be a live show from a user at a terminal who performs a show before a camera such as a web cam. The audio and video signals are sent to the server to broadcast immediately or to save in a buffer memory or database before broadcast. Alternatively, the server also accepts uploading of a prerecorded show by an end user, i.e., the shows to be broadcasted can be live or prerecorded.

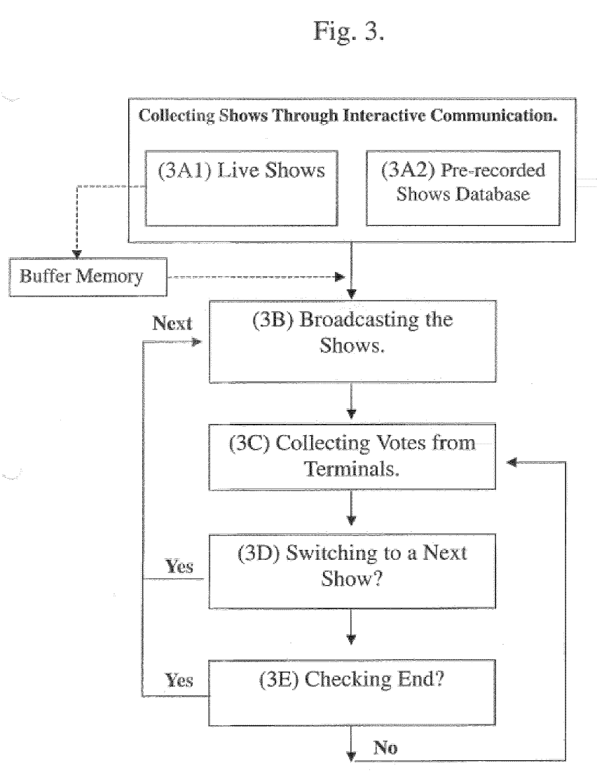

FIG. 3 shows that the collected shows can be Live shows (3A1) or Pre-recorded shows (3A2). The live shows can be saved in a buffer memory before broadcasting so as to avoid blanks in between two shows due to show switching. Steps 3B˜3E are similar to steps 2B˜2E.

Each terminal is authorized to vote on or against an aired show. The vote right can be limited once to each terminal on each aired show to avoid fake votes on the same show. The server collects the votes to determine whether the aired show should continue or skip to play the next show according to a predetermined rule. The rule can be, e.g., that the total votes against the show equal to or greater than a number of 1000. The rule can be, e.g., that the “against” votes are greater than one half of the total number of connected terminals. The vote signal is trigger from a button that can be a terminal button (a virtual button on the terminal screen), a mouse button, keyboard button, or a remote controller button.

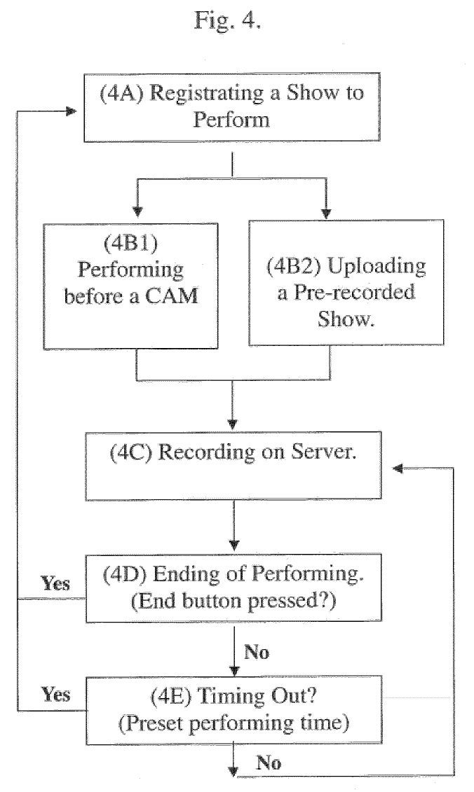

FIG. 4 shows an algorithm at a terminal at which a show is performed or from which a show is uploaded. Firstly, the end user registers a show (4A) according to an interactive request from the server. The end user can perform a show with audio and/or video before a camera (4B1), or upload a pre-recorded show (4B2) to the server. The server records the show sent from the terminal (4C). The server checks whether an END bottom has been pressed by the end user (4D). If the END button is pressed, it shows that the show has finished and the server can stop recording. If the end user is still performing, the server goes to check the time limit (4E) which is a time period preset by the system to allow the end user to perform a show.

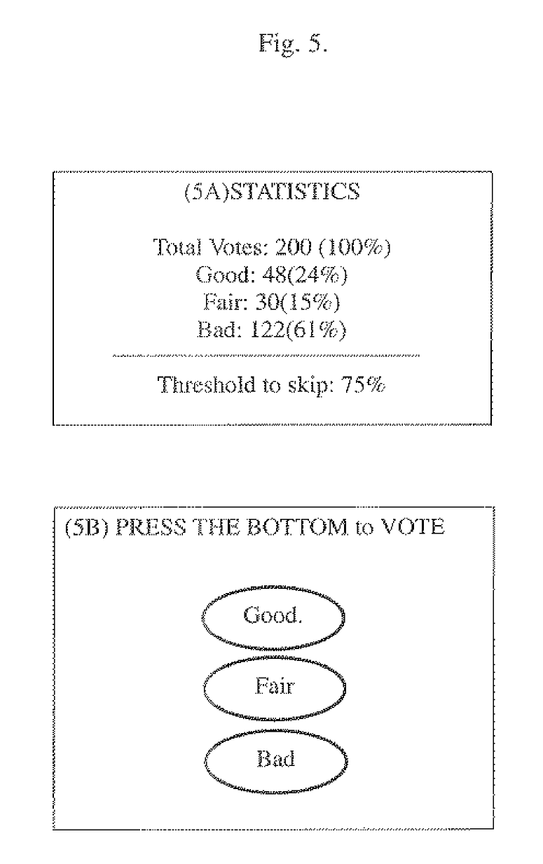

FIG. 5A shows a statistics table which appears on the terminal screen/display to tell the end users the ballot information, e.g. as shown in FIG. 5, a Total number of 200(100%) votes has been received, and Vote Good is 48 (24%), Vote Fair 30 (15%) and Vote Bad 122(61%); and a preset threshold to skip the aired show and play a next one is set to be equal to or larger than 75% of the total votes.

FIG. 5B shows the buttons end user can select to vote. Three buttons are shown as an example, actually an only two button system—“Good Button” and “Bad Button”can be sufficient to serve a similar function.

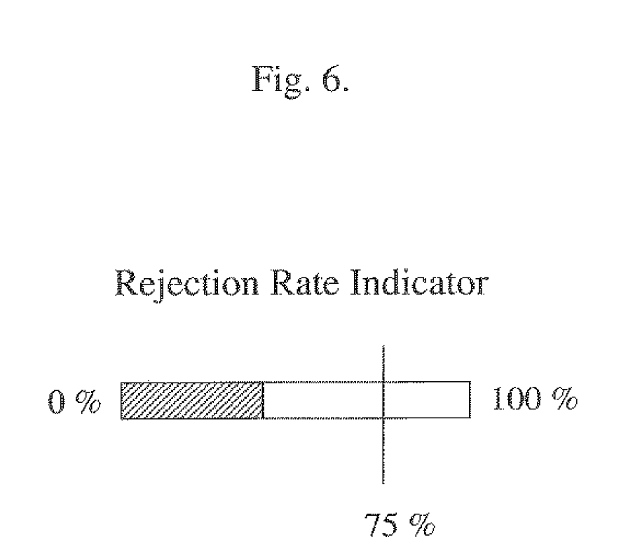

FIG. 6 shows a rejection rate indication. A percentage dynamic drawing with two colors shows the rejection rate on the terminals to show the end users at their terminals the statistics information, and a preset threshold for show skipping. FIG. 6 shows as an example, 40% rejection percentage has been reached and 75% threshold value has been set by the server in advance. When the rejection rate reaches 75%, the show that is broadcasting shall be terminated and a next show shall be played.

The interactive system described in the embodiments of this invention can be an intemnet system; however, a digital TV system controlled by a remote controller can serve a similar function.

While the preferred embodiments have been described, it will be apparent to those skilled in the art that various modifications may be made in the embodiments without departing from the spirit of the present invention. Such modifications are all within the scope of the present invention as defined by the appended claims.

What is claimed is:

1. A method for playing interactive shows, comprising the steps of:
(1) broadcasting said shows sequentially from a server;
(2) collecting votes from terminals signed in to watch the shows; and
(3) switching to a next show based on the votes and according to a predetermined rule.

2. A method for playing interactive shows as claimed in claim 1, wherein at least one of said shows is a live show.

3. A method for playing interactive shows as claimed in claim 1, wherein at least one of said shows is a prerecorded show.

4. A method for playing interactive shows as claimed in claim 1, wherein said shows are collected from viewers at the terminals through interactive communication.

5. A method for playing interactive shows as claimed in claim 1, wherein each terminal is set to vote once for each said show on the air.

6. A method for playing interactive shows as claimed in claim 1, wherein said predetermined rule is based on a quantity of the votes.

7. A method for playing interactive shows as claimed in claim 1, wherein said predetermined rule is based on a ratio of the votes.

8. A method for playing interactive shows as claimed in claim 1, wherein said shows are played on an intemnet system.

9. A method for playing interactive shows as claimed in claim 1, wherein said shows are played on a digital TV system.

10. A method for playing interactive shows as claimed in claim 4, wherein one of said viewers performs a live show responsive to said interactive communication.

11. A method for playing interactive shows as claimed in claim 4, wherein one of said viewers uploads a prerecorded show responsive to said interactive communication.

12. A method for playing interactive shows as claimed in claim 10, said live show is limited to a time period preset by the server.

13. A method for playing interactive shows as claimed in claim 11, said uploaded show is limited to a time period preset by the server.

14. A method for playing interactive shows as claimed in claim 5, wherein said vote is triggered by selecting a button.

15. A method for playing interactive shows as claimed in claim 14, wherein said button is selected from the group consisting of a terminal button, a mouse button, a keyboard button, and a remote controller button.

16. A method for playing interactive shows as claimed in claim 1, further comprising displaying statistics information on screens of the terminals to inform the end users of the ballot information.

17. A method for playing interactive shows as claimed in claim 16, wherein said statistics information is a table.

18. A method for playing interactive shows as claimed in claim 16, wherein said statistics information is a percentage dynamic drawing.
